(19) United States
(12) Patent Application Publication
(10) Pub. No.: US 2009/0273770 A1
(43) Pub. Date: Nov. 5, 2009

(54) SYSTEMS AND METHODS FOR SAFE LASER IMAGING, DETECTION AND RANGING (LIDAR) OPERATION

(75) Inventors: Paul E. Bauhahn, Fridley, MN (US); Bernard S. Fritz, Eagan, MN (US); Brian C. Krafthefer, Stillwater, MN (US)

Correspondence Address: HONEYWELL INTERNATIONAL INC.;PATENT SERVICES AB-2B, 101 COLUMBIA ROAD, P.O. BOX 2245, MORRISTOWN, NJ, 07962-2245, US

(73) Assignee: HONEYWELL INTERNATIONAL INC., Morristown, NJ (US)

(21) Appl. No.: 12/112,517

(22) Filed: Apr. 30, 2008

(51) Int. Cl. G01C 3/08

(52) U.S. Cl. 356/5.01

(57) ABSTRACT

A Laser Imaging, Detection and Ranging (LIDAR) system that automatically adjusts laser output so that no eye damage occurs to human targets. In one example, a component automatically measures range to targets in a field of view and determines the closest targets based on the measured range. A laser device outputs a laser beam and a controller adjusts one of pulse repetition frequency, power, or pulse duration of the laser device based on the measured range of the closest target in order to comply with a predefined eye safety model.

### BACKGROUND OF THE INVENTION

Laser Imaging, Detection and Ranging (LIDAR) systems are measuring systems that detect and locate objects using the same principles as radar, but use light from a laser. LIDAR systems can be used on aircraft, for example, for a number of purposes. One example of a LIDAR system on an aircraft is an altimeter which uses laser range finding to identify a height of the aircraft above the ground. Another example of a LIDAR system on an aircraft could include a system which detects air turbulence. Other uses on aircraft are possible, for example including on-ground range finding for purposes of on-ground navigation of aircraft in proximity to airports, etc. Non-aircraft uses of LIDAR systems are also possible.

One potential problem with LIDAR systems relates to the intensity of the lasers used. While an aircraft is on the ground or flying at low airspeeds and altitude, people on the ground could be exposed to this hazard.

### SUMMARY

The present invention provides a Laser Imaging, Detection and Ranging (LIDAR) or Laser Radar (LADAR) system that automatically adjusts laser output so that no eye damage occurs to a human target.

In one aspect of the present invention, a component automatically measures range to one or more targets in a field of view and determines the closest one of the targets based on the measured range. A laser device outputs a laser beam and a controller adjusts one of pulse repetition frequency, power, or pulse duration of the laser device based on the measured range of the closest target in order to comply with a predefined eye safety model.

In another aspect of the present invention, the component includes an acoustic target measuring device that outputs an acoustic signal, detects reflections of the outputted acoustic signal, and measures the range of targets based on the outputted acoustic signal and the detected reflections.

In still another aspect of the present invention, the eye safety model is based on the type of laser beam outputted by the laser device. The eye safety model is further based on atmospheric conditions.

In yet another aspect of the present invention, the system includes a device that automatically determines atmospheric conditions.

In still yet another aspect of the present invention, the laser device is used as the component that measures range.

### BRIEF DESCRIPTION OF THE DRAWINGS

Preferred and alternative embodiments of the present invention are described in detail below with reference to the following drawings:

FIG. 1 illustrates a schematic diagram of an embodiment of the present invention in operation;

FIGS. 2 and 3 illustrate various embodiments of the components of the device shown in FIG. 1;

FIG. 4 illustrates a flow diagram performed by the devices shown in the FIGS. 1-3; and

FIG. 5 illustrates another embodiment of a system formed in accordance with an embodiment of the present invention.

### DETAILED DESCRIPTION OF THE INVENTION

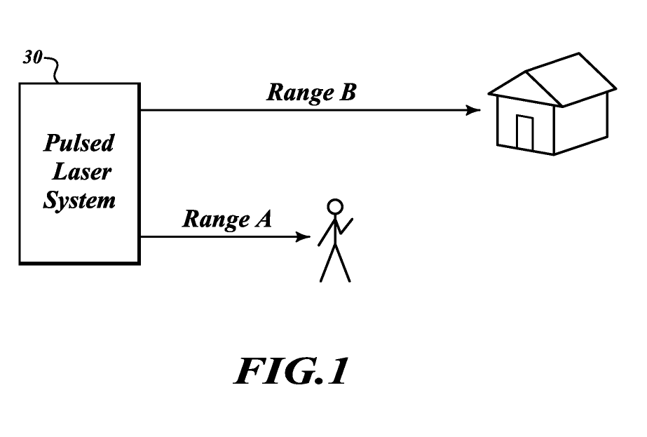

FIG. 1 illustrates an example laser system 30 that performs automatic range sensing and adjustment of an outputted laser beam (pulse) in order to reduce the eye hazard caused by the outputted laser beam. The system 30 is a pulsed laser system, such as a Laser Imaging Detection and Ranging (LIDAR) or Laser Detection and Ranging (LADAR) system.

The laser system 30 is initially set to optimize return signals at a first desired range, Range B. Range B is selected based on approximate distance to objects that the operator is expecting to detect targets. The power of the laser system 30 is optimized to produce the most accurate results for detecting targets at Range B. The power setting for the laser system 30 is set such that if there was a human at Range B the power and intensity of the outputted laser beam would not cause any significant eye, skin or other damage to that person. However, within a distance (Range A) less than Range B the laser system 30 would be hazardous to a human.

If a target is detected that is at a range that is less than Range B (Range A) and it is determined by the laser system 30 that damage to a human eye would occur if the present power and intensity levels of the laser system 30 were maintained, then the laser system 30 automatically adjusts the power or intensity settings to a level that would be compatible with a human eye at Range A. The laser system 30 continuously makes this adjustment in order to provide laser beam outputs that are in safety compliance with human operation.

The LIDAR or LADAR system measures the range to a target by transmitting pulses of light from a laser. These pulses reflect off the target and return to an optical receiver (an optical detector diode and low-noise amplifiers). A precision timer measures the total time of flight to and from the target. The timer starts when the laser pulse is triggered and stops when the optical receiver detects the reflected signal. If the signal is strong enough, the range from a single pulse transit time can be determined. This is the common situation at close range when eye-safety is of the most concern. One pulse is probably insufficient to damage the eyes. Knowing the range, the laser pulse amplitude, repetition frequency or the optical intensity (by adjusting the transmitter optics) can be adjusted to ensure that the overall light intensity is eye-safe.

If there is not enough pulsed light intensity to detect reflections of the pulse in the presence of background noise (e.g., sunlight) and determine the range with a single pulse, the light from multiple pulses is summed. Since the signal intensity increases directly with the number of pulses and detected noise only increases with the square root of the sum of the noise, the range is measured using some reasonable number of pulses. This situation tends to occur at longer ranges and reduced eye-safety hazards.

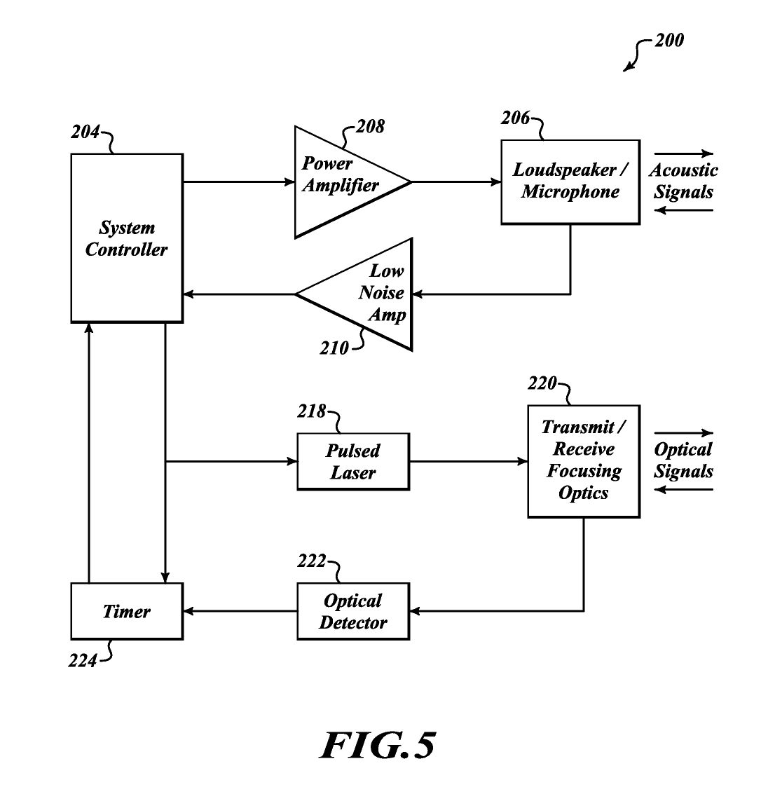

While the LIDAR or LADAR system is normally used to measure the range to a target they have other potential functions where the return signal provides other diagnostic information and alternative methods for range measurement can be used. At shorter ranges acoustic time of flight can be used (FIG. 5), ranges from the lens positions using image contrast measurements can be calculated using stereo cameras, etc. Using ranges derived from any of these techniques, estimates of the light intensity at the point of reflections are derived to calculate eye-safety hazards and change the laser output to avoid them.

In another embodiment, since it is not immediately know the range of any targets (person), the laser intensity is started at levels much lower than the safety threshold for the closest distance possible. Then, the distance of a closest person/target is determined. This can be done by slowly increasing laser power until a range of the closest person/target is attained. The laser power (or other laser setting) is then set at that level for the determined distance. The key point being that the system starts off at a minimal power and then is slowly increased.

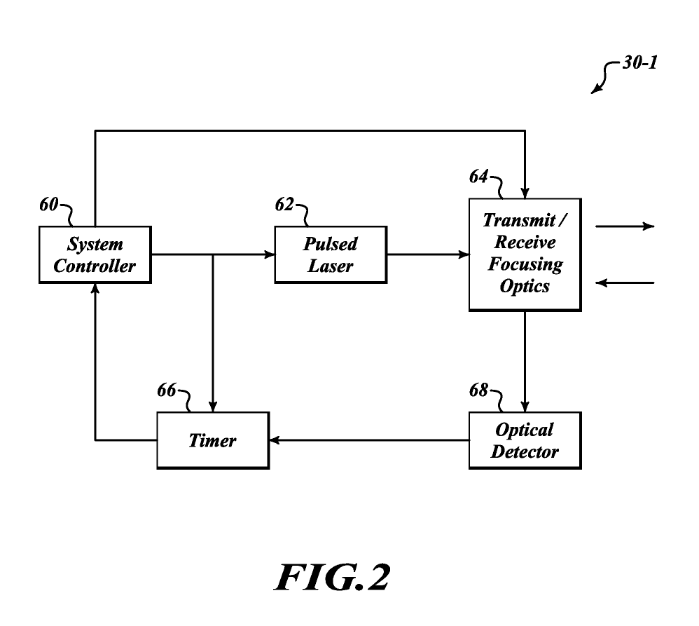

As shown in FIG. 2, an example laser system 30-1 performs the functions as described above with regard to the laser system 30 of FIG. 1. The laser system 30-1 includes a system controller 60, a pulsed laser 62, transmit and receive focusing optics 64, an optical detector 68, and a timer 66. The system controller 60, such as a general purpose computer including processor and memory, controls operation of the pulsed laser 62 and the transmit and receive focusing optics 64. The laser beam output of the pulsed laser 62 is sent to the transmit and receive focusing optics 64 which focuses the laser beam. The optical detector 68 receives signals that the transmit and receive focusing optics 64 receive from the reflection of the outputted laser beam. The timer 66 receives a timing signal included in the control signal sent by the system controller 60 to the pulsed laser 62 and a timing signal produced by the optical detector 68. The timer 66 passes the collected timing information to the system controller 60. The system controller 60 can then determine the range of any targets detected by the optical detector 68 based on the timing signals.

Once the system controller 60 determines the range of a target by using the optical time as determined by the timer 66, the laser outputted by the pulsed laser 62 (pulse repetition frequency, power or pulse duration) is altered based on range and safety requirements. Example eye safety requirements are included in American National Standard ANSI Z 136.1 2007.

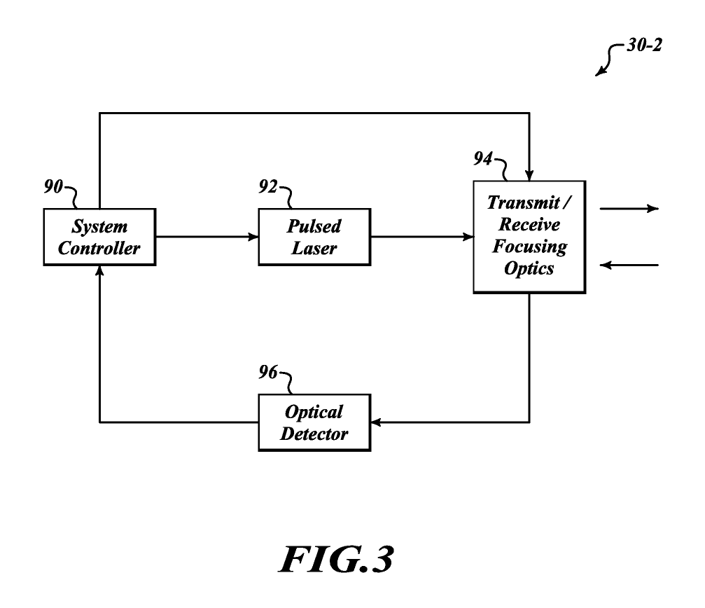

FIG. 3 illustrates an embodiment of another laser system 30-2 formed in accordance with the present invention. The laser system 30-2 includes a system controller 90, a pulsed laser 92, transmit and receive focusing optics 94 and an optical detector 96. Like the system controller 60 shown in FIG. 2, the system controller 90 performs similar operations for controlling the pulsed laser 92 and the transmit and receive focusing optics 94. The optical detector 96 is connected to the transmit and receive focusing optics 94 in a similar manner as optical detector 68 as described above in FIG. 2. The system 30-1 does not include a timer. The system controller 90 adjusts the focusing optics 94 to maximize the contrast and the return signal level. The range is estimated by the position of the lenses (the focusing optics 94) in an entirely separate imaging optical system.

Once the system controller 90 has determined the range of a target, then the adjusting of the pulse repetition frequency, power or pulse duration are adjusted.

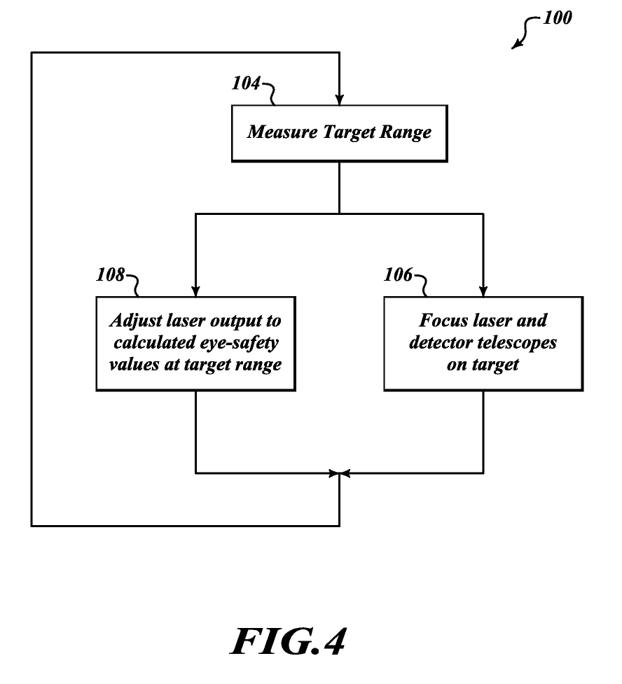

FIG. 4 illustrates an example flow diagram of a process 100 performed by the systems described above. First, at a block 104, range to a target is measured. Next, simultaneous operation may occur as described in blocks 106 and 108. At the block 106, the focusing optics are focused on the identified target. The focusing of the optics can be formed automatically based on contrast or reflected signal amplitude optimization techniques. Focusing may also occur manually as performed by a user operator interfacing with the optics. At the block 108, the output of the laser is automatically adjusted to previously calculated eye safety laser settings with respect to the measured target range. The process returns to the block 104 as long as the system is activated. The previously calculated eye or tissue safety laser settings may be adjusted based on a number of factors. Example factors that may be taken into consideration in modeling safety values include atmospheric conditions. For example, conditions such as humidity level or the visible presence of fog or other optical impairments, such as smoke, rain or snow, may be taken into consideration for modeling eye safety values. Determination of these factors may be performed manually or automatically depending upon what systems are available to the operator. For example, automatic or manual analysis of the received return signals determine whether a meteorological condition exists. Other sensors may be used to determine existence and type of meteorological condition.

In one embodiment, a look-up table stores default laser system settings relative to target range. If an environmental condition was determined to exist, then a scale factor may be applied to the laser system settings (i.e. eye safety laser settings, or pulse repetition frequency, power, pulse duration or comparable value). The look-up table may include laser system settings that are based on the environmental condition.

FIG. 5 illustrates another embodiment of an example system 200 that performs an adjusting of a laser beam in order to comply with eye safety standards. The system 200 includes a system controller 204 that is connected to a pulsed laser 218, transmitter and receiver focusing optics 220, an optical detector 222, a timer 224, in a similar manner as to that described in FIG. 2. The laser system components may be similar to those shown in FIG. 3. The system 200 also includes a power amplifier 208 that receives a power signal produced by the system controller 204 and outputs the amplified signal to a loudspeaker included in a loudspeaker and microphone component 206. The loudspeaker outputs an acoustic signal that reflects off targets. The reflection is received by a microphone in the loudspeaker and microphone component 206. The signal produced by the microphone is outputted to a low-noise amplifier 210, which applies the received signal and outputs the amplified signal to the system controller 204.

The system controller 204 determines ranges of objects based on the signals sent to and received from the acoustic components 206, 208, and 210. From the determined range information, the system controller 204 controls the laser 218 and/or focusing optics 220 according to predefined eye safety standards. Control of the laser 218 and/or focusing optics 220 is performed similar to that described above with regard to FIGS. 2-4.

In another embodiment, the system controllers 60, 90, 120 may include the ability to analyze return signals in order to determine whether the target is a human or non-human. This can be done by performing a form of image analysis to determine if the target forms a shape that is comparable to a human form.

In another embodiment, a continuous wave (CW) laser may be used. However, it would preferably to perform ranging by other systems, such as an autofocus camera, acoustic ranging (typically for short range), triangulation (with multiple cameras) in a stereo application.

An optical system (not shown) can be used to reduce the initiation power. A neutral density filter of sufficient strength can be used to produce a higher amplitude laser signal. Beam widening optics may be used with constant average laser power to reduce the light intensity on the target, thereby eliminating the eye-safety hazard.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is: claimed are defined as follows:

1. A method for controlling output of a Laser Imaging, Detection and Ranging (LIDAR) system, the method comprising:
automatically measuring range to one or more targets in a field of view;
determining the closest one of the targets based on the measured range; and
adjusting at least one of pulse repetition frequency, pulse amplitude, power, pulse duration, or optical intensity of a laser device based on the measured range of the closest target in order to comply with predefined human tissue safety model.

2. The method of claim 1, wherein the human tissue safety model includes at least one of an eye safety model or a skin safety model.

3. The method of claim 1, wherein automatically measuring range comprises sweeping a laser pulse outputted by the laser device through the field of view.

4. The method of claim 3, wherein the laser device includes a pulsed laser.

5. The method of claim 1, wherein automatically measuring range comprises outputting an acoustic signal, detecting a reflection of the outputted acoustic signal off of a target, determining time of travel based on the outputted acoustic signal and the detected reflection, and measuring range of targets based on the determined time of flight.

6. The method of claim 1, wherein the human tissue safety model is based on type of laser beam outputted by the laser device.

7. The method of claim 6, wherein the human tissue safety model is further based on atmospheric conditions.

8. The method of claim 7, further comprising automatically determining atmospheric conditions.

9. A Laser Imaging, Detection and Ranging (LIDAR) system comprising:
a component configured to automatically measure range to one or more targets in a field of view and determine the closest one of the targets based on the measured range;
a laser device configured to output a laser beam; and
a controller configured to adjust at least one of pulse repetition frequency, pulse amplitude, power, pulse duration, or optical intensity of the laser device based on the measured range of the closest target in order to comply with predefined human tissue safety model.

10. The system of claim 9, wherein the human tissue safety model includes at least one of an eye safety model or a skin safety model.

11. The system of claim 9, wherein the laser device includes a pulsed laser.

12. The system of claim 9, wherein the component comprises an acoustic target measuring device configured to output an acoustic signal, detect reflections of the outputted acoustic signal, and measure range of targets based on the outputted acoustic signal and a determined time of flight of the detected reflections.

13. The system of claim 9, wherein the human tissue safety model is based on type of laser beam outputted by the laser device.

14. The system of claim 13, wherein the human tissue safety model is further based on atmospheric conditions.

15. The system of claim 14, further comprising a device configured to automatically determine atmospheric conditions.

16. A Laser Imaging, Detection and Ranging (LIDAR) system comprising:
a means for outputting a laser pulse;
a means for sensing reflections of the outputted laser pulse;
a component configured to measure range to one or more targets based on the sensed returns and determine the closest one of the targets based on the measured range; and
a controller configured to adjust at least one of pulse repetition frequency, pulse amplitude, power, pulse duration, or optical intensity of the laser device based on the measured range of the closest target in order to comply with predefined human tissue safety model.
